(19) United States
(12) Patent Application Publication
(10) Pub. No.: US 2007/0192830 A1
(43) Pub. Date: Aug. 16, 2007

(54) Security module having access limited based upon security level of code seeking access

(76) Inventor: Dennis M. O'Connor, Chandler, AZ (US)

Correspondence Address: THE LAW OFFICES OF JOHN C. SCOTT, LLC;C/O INTELLEVELE, P. O. BOX 52050, MINNEAPOLIS, MN, 55402, US

(21) Appl. No.: 11/354,676

(22) Filed: Feb. 15, 2006

(51) Int. Cl. H04L 9/32

(52) U.S. Cl. 726/2

(57) ABSTRACT

Access to secrets and/or security related functionality within a security module (e.g., a platform trust module, etc.) is limited based upon a security level associated with a program seeking access to the secrets/functionality within a digital platform.

### TECHNICAL FIELD

The invention relates generally to digital security and, more particularly, to techniques for limiting access to secrets and/or security related functionality within a security module.

### BACKGROUND OF THE INVENTION

Security is quickly becoming a major concern in a wide range of different digital products. As the mobility of digital devices increases, and the channels of communication between such devices and the outside world become more plentiful and more sophisticated, there is growing need to provide adequate protection for important data and other “secrets” that may be stored within a digital device. With the increasing popularity of e-commerce, high bandwidth data services, and other digital transactions, it has also become more important to be able to accurately and reliably authenticate digital devices and associated users, even from remote locations. To combat the various security risks associated with digital devices, hardware-based security modules (e.g., trusted platform modules (TPMs), etc.) have been developed to, for example, aid in the protection of secrets on digital platforms, facilitate the authentication of platforms, prevent unauthorized access to platforms, prevent unauthorized access to outside networks and services, and/or perform other security related functions. It is believed that such security modules will play an increasingly important role as both the number and the capabilities of digital devices increase in the coming years. Therefore, there is a general need for methods and structures for improving the effectiveness of digital security modules.

### BRIEF DESCRIPTION OF THE DRAWINGS

FIG. 1 is a block diagram illustrating an example digital device in accordance with an embodiment of the present invention; and

FIG. 2 is a flowchart illustrating an example method for limiting access to a security module in a digital platform in accordance with an embodiment of the present invention.

### DETAILED DESCRIPTION

In the following detailed description, reference is made to the accompanying drawings that show, by way of illustration, specific embodiments in which the invention may be practiced. These embodiments are described in sufficient detail to enable those skilled in the art to practice the invention. It is to be understood that the various embodiments of the invention, although different, are not necessarily mutually exclusive. For example, a particular feature, structure, or characteristic described herein in connection with one embodiment may be implemented within other embodiments without departing from the spirit and scope of the invention. In addition, it is to be understood that the location or arrangement of individual elements within each disclosed embodiment may be modified without departing from the spirit and scope of the invention. The following detailed description is, therefore, not to be taken in a limiting sense, and the scope of the present invention is defined only by the appended claims, appropriately interpreted, along with the full range of equivalents to which the claims are entitled. In the drawings, like numerals refer to the same or similar functionality throughout the several views.

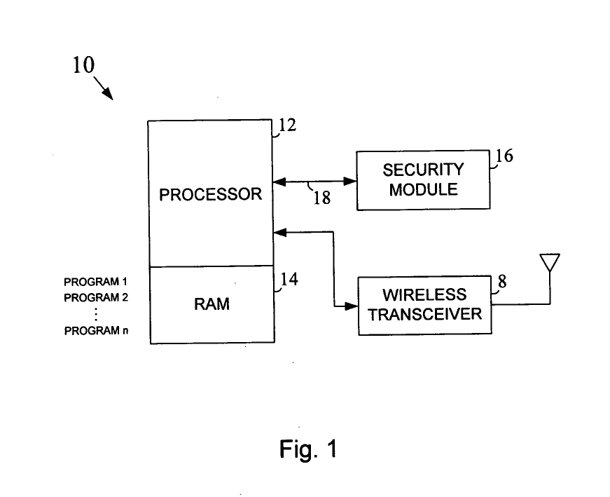

FIG. 1 is a block diagram illustrating an example digital device 10 in accordance with an embodiment of the present invention. The digital device 10 may be any of a wide variety of different digital products including, for example, a laptop, palmtop, desktop, or tablet computer; a personal digital assistant (PDA); a cellular telephone or other handheld wireless communicator; a satellite communicator; and/or others. As illustrated, the device 10 may include: a digital processor 12, random access memory (RAM) 14, and a security module 16. The processor 12 is operative for, among other things, executing one or more programs stored within the RAM 14. The security module 16 is operative for performing one or more security related functions for the digital device 10. Programs executing within the processor 12 are able to send commands to the security module 16 when the programs require security related functions to be performed that are supported by the security module 16. The processor 12 and the security module 16 may communicate with one another through an interconnect 18. Any type of interconnect may be used including, for example, a bus structure, a high speed data line, and/or others. In at least one embodiment, the processor 12 and the security module 16 are separate units that are mounted on a common circuit board (e.g., a mother board within a computing device, etc.). In some other embodiments, the security module 16 is implemented on a common chip with the processor 12. Separate chips within a common circuit package may also be used. Other arrangements are also possible.

The processor 12 can be any of a variety of different digital processing device types. For example, the processor 12 may be a general purpose microprocessor, a digital signal processor, a reduced instruction set computer (RISC), a complex instruction set computer (CISC), an application specific integrated circuit (ASIC), a field programmable gate array (FPGA), a microcontroller, a multi-core processor, and/or others. Multiple processors that share a common security module 16 may also be used. The processor 12 is not necessarily the main processor or central processing unit (CPU) of the digital device 10, but can also be a secondary or supplementary processor of the device. The processor 12 that is coupled to the security module 16 will typically be the processor (or processors) that will need to access the security functionality within the module 16 during device operation. In at least one embodiment, the processor 12 is a chipset of the digital device 10, although many other arrangements also exist.

The digital device 10 will typically include some communication functionality to enable the device to communicate with one or more remote entities. This communication functionality may support wireless and/or wired communication. In the embodiment of FIG. 1, for example, the device 10 includes a wireless transceiver module 8 that is capable of supporting a wireless communication link with one or more remote wireless entities. The wireless transceiver module 8 may be configured in accordance with, for example, one or more wireless networking standards and/or one or more wireless cellular standards. Examples of other or alternative communication functionality that may be included within the digital device 10 in various embodiments include: Ethernet LAN cards, satellite transceivers, telephone modems, infrared (IR) ports, and/or others. While enabling a device to communicate with external entities, such communication functionality may also increase the likelihood that hackers and data thieves will be able to obtain access to the digital device 10 and possibly steal secrets stored therein.

As described previously, the security module 16 is operative for performing one or more security related functions for the digital device 10. The security module 16 may, for example, provide secure storage for one or more “secrets” that a user of the device 10 wants to hide from, for example, hackers and data thieves. As used herein, a “secret” may be any information that a user wishes to keep confidential. Secrets may include, for example, encryption keys, authentication information, endorsement certificates, passwords, bank account information, credit card information, personal information, and/or other information. The security module 16 may also provide encryption/decryption functions, authentication functions, and/or other security related functions that can be used by, for example, one or more programs being executed by the processor 12. The programs may be able to send commands to the security module 16 when they require security related functions to be performed.

The security module 16 may include digital processing functionality that is capable of performing the supported security functions. For example, in one embodiment, the security module 16 may include a secure microcontroller or other processor. The digital processing functionality may be used to provide various cryptography functions for the device 10. The cryptography functions will typically be performed within the module hardware and entities outside the security module 16 will not have access to the execution of these functions. The security module 16 may also include, for example, encryption/decryption hardware, such as an RSA engine, etc. to perform public key encryption. An RSA engine may be used during, for example, digital signing operations and/or key wrapping operations. In some embodiments, the security module 16 may also include a hash engine or similar hardware to compute hash values for input data. One type of security module that may be used in accordance with the invention is a trusted platform module (TPM) as described in Trusted Computing Platform Alliance (TCPA) Main Specification, Version 1.1b, published by the Trusted Computing Group, 2003. Other similar devices may alternatively be used.

In one aspect of the present invention, the security module 16 will not treat commands from all programs executing within the processor 12 the same. That is, the security module 16 will control access to its protected secrets and/or security functionality based on a “security level” associated with code issuing a command to the module. Programs to be executed within the processor 12 may each have a security level associated with it that is related to the level of trust that the program is deemed to possess. Thus, programs that are very trustworthy may have a high security level while programs that are less trustworthy (e.g., programs that are easily hacked, etc.) may have a lower security level. Any number of different security levels (i.e., two or more) may be used to describe the programs resident on a particular platform.

When a program issues a command to the security module 16, the module will determine the security level of the issuing program and limit the access of the program based thereon. For example, in one embodiment, the security module 16 may limit the secrets that are available for use by a particular program based on the security level of the program. In another embodiment, the security module 16 may limit the security related processing functions that are available to a program based on the security level of the program. In yet another embodiment, the security module 16 may limit both the secrets and the security related processing functions that are available to a program based on security level. For example, the security module 16 may only allow programs having a highest security level to use certain types of encryption. Similarly, the security module 16 may only allow programs having a highest security level to have access to certain encryption keys (or other secrets) stored within the module.

In at least one embodiment, a security level condition may be established for each different security function that may be provided by the security module 16. For example, a particular type of encryption may require that a program issuing a command for that encryption have a security level at or above a specified level. Another possible condition may be that only programs having one or more specified security levels may use that type of encryption. Security level conditions may also be specified for different secrets stored within the module 16 (e.g., for different secrets stored within the module, etc.).

The security levels that are used to categorize the programs on a digital platform may be established in a number of different ways. For example, in one approach, a user associated with a platform may specify the number of security levels to be used for the platform and which level to assign to each program. Programs that are not assigned a security level may be given a default level by the device (e.g., the lowest security level). In another possible approach, levels that are already assigned by a processor manufacturer or other entity may be used as the security levels regulating access to the security module 16. For example, ARM® is a manufacturer of digital products that has developed a security technology known as Trustzone® technology. While using the Trustzone® technology, some of the programs on a platform may be operated in a “secure” mode while other programs may be operated in a “non-secure” mode. In at least one embodiment of the invention, this designation of secure mode and non-secure mode may be used by a security module as an indicator of the security level of executing programs.

In an ARM Trustzone enabled platform, bits are usually included on the ARM bus that indicate whether a command currently on the bus was issued by a secure mode or non-secure mode program. In at least one embodiment, the security module 16 may simply latch these bits to determine the security level of the issuing code. Other systems may identify programs as executing in either “supervisor mode” or “user mode.” These may also be used as security levels in a similar manner. In another possible approach, in a system where a module reads instructions off of a list residing in memory, certain bits in the commands, as well as restrictions on the order and memory of commands in the list, may be used to identify security levels associated with the issuing programs.

Other techniques for determining security levels associated with programs may alternatively be used. For example, in systems based on Intel Architecture processors, the ring level of the executing code may be used. As another example, the processor may indicate a security level based on which instructions are being executed, thus allowing security functions built-in to the processor exclusive access to some secrets or algorithms in the security module.

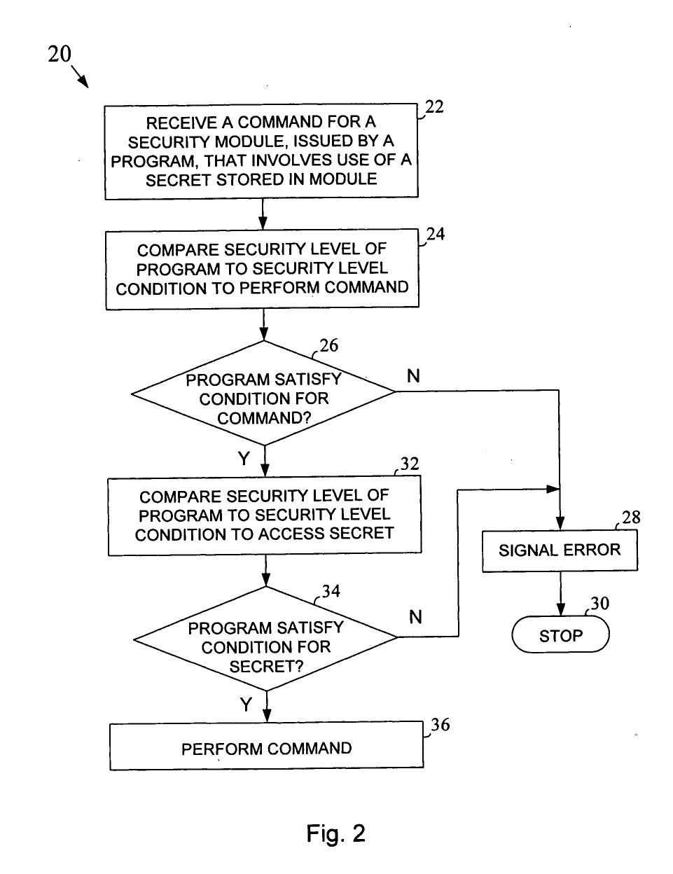

FIG. 2 is a flowchart illustrating an example method 20 for limiting access to a security module in a digital platform in accordance with an embodiment of the present invention. The method 20 may be implemented within, for example, the security module 16 of FIG. 1 or in other similar environments. A command is first received that requests that a particular security function be performed by a security module (block 22). Performance of the requested function may require that a particular secret stored within the security module be used. The command was issued by a particular program being executed within an associated processor. A security level of the command issuing program is determined and the security level is compared to a security level condition that is required to perform the requested function in the security module (block 24). The security level conditions that are associated with the various security functions of the security module may be stored within the security module itself. The security level condition associated with a function of the security module may be expressed in a variety of ways. For example, the condition may require that the security level of the program issuing the command be at or above a specified level for the function to be performed. In another example, the condition may identify one or more levels that the security level of the program must match for the function to be performed.

If the program that issued the command does not satisfy the security level condition associated with the requested function (block 26-N), an error signal may be delivered to a user of the corresponding platform (block 28) and the method 20 may then terminate (block 30). If the program does satisfy the security level condition associated with the requested function (block 26-Y), the security level of the program may then be compared to a security level condition associated with the secret identified within the command, if any (block 32). As with the security level condition associated with the requested function, if the program does not satisfy the security level condition associated with the secret (block 34-N), an error signal may be delivered to the user of the platform (block 28) and the method 20 may terminate (block 30). Otherwise, the requested function will be performed (block 36).

In the method 20 illustrated in FIG. 2, the criterion for performing the function associated with the command requires that the security level of the issuing program satisfy the security level conditions associated with both the commanded function and the identified secret. In other embodiments, the criterion may only require that a single security level condition be checked (e.g., only a condition related to commanded function, only a condition related to secret access, and so on). Other criteria for determining whether to perform a security related function based on a security level associated with a command issuing program may alternatively be used.

The techniques and structures of the present invention may be implemented in any of a variety of different forms. For example, features of the invention may be embodied within laptop, palmtop, desktop, and tablet computers; personal digital assistants (PDAs); cellular telephones and other handheld wireless communicators; pagers; satellite communicators; network interface cards (NICs) and other network interface structures; base stations; wireless access points; integrated circuits; security modules; trusted platform modules; as instructions and/or data structures stored on machine readable media; and/or in other formats. Examples of different types of machine readable media that may be used include floppy diskettes, hard disks, optical disks, compact disc read only memories (CD-ROMs), digital video disks (DVDs), Blu-ray disks, magneto-optical disks, read only memories (ROMs), random access memories (RAMs), erasable programmable ROMs (EPROMs), electrically erasable programmable ROMs (EEPROMs), magnetic or optical cards, flash memory, and/or other types of media suitable for storing electronic instructions or data.

In the foregoing detailed description, various features of the invention are grouped together in one or more individual embodiments for the purpose of streamlining the disclosure. This method of disclosure is not to be interpreted as reflecting an intention that the claimed invention requires more features than are expressly recited in each claim. Rather, as the following claims reflect, inventive aspects may lie in less than all features of each disclosed embodiment.

Although the present invention has been described in conjunction with certain embodiments, it is to be understood that modifications and variations may be resorted to without departing from the spirit and scope of the invention as those skilled in the art readily understand. Such modifications and variations are considered to be within the purview and scope of the invention and the appended claims.

What is claimed is:

1. A method comprising:
detecting a command requesting that a function be performed by a security module;
determining whether a security level of a program that issued said command satisfies a predetermined criterion; and
performing said function when said security level of said program satisfies said predetermined criterion.

2. The method of claim 1, wherein:
determining includes determining whether said security level of said program satisfies a security level condition associated with said function.

3. The method of claim 1, wherein:
said command identifies a secret stored within said security module that is to be used to execute said command; and
determining includes determining whether said security level of said program satisfies a security level condition associated with said secret.

4. The method of claim 3, wherein:
said security level condition associated with said secret indicates that only programs having security levels at or above a predetermined security level may use said secret.

5. The method of claim 3, wherein:
said security level condition associated with said secret indicates that only programs having a predetermined security level may use said secret.

6. The method of claim 3, wherein:
said security level condition associated with said secret indicates that only programs having security levels at or below a predetermined security level may use said secret.

7. The method of claim 1, wherein:
said command identifies a secret stored within said security module that is to be used to execute said command; and
determining includes determining whether said security level of said program satisfies a security level condition associated with said function and also satisfies a security level condition associated with said secret.

8. The method of claim 7, wherein:
said security level condition associated with said function can be different from said security level condition associated with said secret.

9. The method of claim 1, wherein:
said security module is a trusted platform module.

10. The method of claim 1, further comprising:
determining said security level of said program before determining whether said security level of said program satisfies said predetermined criterion.

11. The method of claim 10, wherein:
determining said security level of said program includes detecting predetermined bits on a transmission structure carrying said command to said security module.

12. The method of claim 10, wherein:
said security module reads commands out of a stored list; and
determining said security level of said program includes analyzing restrictions on the order and memory location of commands in said list.

13. An apparatus comprising:
a processor to execute programs stored in a random access memory; and
a security module, in communication with said processor, to perform one or more security related functions for said apparatus, said security module having at least one protected secret stored therein, said security module having logic to:
receive a command from said processor that requests the performance of a specified function;
determine whether a security level of a program that issued said command satisfies a predetermined criterion; and
perform said requested function when said program that issued said command has a security level that satisfies said predetermined criterion.

14. The apparatus of claim 13, wherein:
said logic is to determine whether said security level of said program satisfies a security level condition associated with said function when determining whether said security level satisfies said predetermined condition.

15. The apparatus of claim 13, wherein:
said command identifies a secret stored within said security module that is to be used to execute said command; and
said logic is to determine whether said security level of said program satisfies a security level condition associated with said secret when determining whether said security level satisfies said predetermined condition.

16. The apparatus of claim 13, wherein:
said command identifies a secret stored within said security module that is to be used to execute said command; and
said logic is to determine whether said security level of said program satisfies a security level condition associated with said secret and also whether said security level of said program satisfies a security level condition associated with said function when determining whether said security level satisfies said predetermined condition.

17. The apparatus of claim 13, wherein:
said security module is a trusted platform module.

18. The apparatus of claim 13, wherein:
said logic is to determine said security level of said program before determining whether said security level of said program satisfies said predetermined criterion.

19. The apparatus of claim 18, wherein:
said logic is to detect predetermined bits on a transmission structure carrying said command to said security module in order to determine said security level of said program.

20. The apparatus of claim 18, wherein:
said security module reads commands out of a stored list; and
said logic is to analyze restrictions on the order and memory location of commands in said list in order to determine said security level of said program.

21. An article comprising a storage medium having instructions stored thereon that, when executed by a computing platform, operate to:
detect a command requesting that a function be performed by a security module;
determine whether a security level of a program that issued said command satisfies a predetermined criterion; and
perform said function when said security level of said program satisfies said predetermined criterion.

22. The article of claim 21, wherein:
operation to determine whether said security level of said program satisfies said predetermined criteria includes operation to determine whether said security level of said program satisfies a security level condition associated with said function.

23. The article of claim 21, wherein:
said command identifies a secret stored within said security module that is to be used to execute said command; and
operation to determine whether said security level of said program satisfies said predetermined criteria includes operation to determine whether said security level of said program satisfies a security level condition associated with said secret.

24. A system comprising:
a wireless transceiver to facilitate wireless communication between said system and at least one remote wireless entity;
a processor to execute programs stored in a random access memory; and
a security module, in communication with said processor, to perform one or more security related functions for said apparatus, said security module having at least one protected secret stored therein, said security module having logic to:
receive a command from said processor that requests the performance of a specified function;
determine whether a security level of a program that issued said command satisfies a predetermined criterion; and
perform said requested function when said program that issued said command has a security level that satisfies said predetermined criterion.

25. The system of claim 24, wherein:
said logic is to determine whether said security level of said program satisfies a security level condition associated with said function when determining whether said security level satisfies said predetermined condition.

26. The system of claim 24, wherein:
said command identifies a secret stored within said security module that is to be used to execute said command; and
said logic is to determine whether said security level of said program satisfies a security level condition associated with said secret when determining whether said security level satisfies said predetermined condition.
